(19) United States
(12) Patent Application Publication
(10) Pub. No.: US 2016/0259888 A1
(43) Pub. Date: Sep. 8, 2016

(54) METHOD AND SYSTEM FOR CONTENT MANAGEMENT OF VIDEO IMAGES OF ANATOMICAL REGIONS

(71) Applicant: SONY CORPORATION, TOKYO (JP)

(72) Inventors: MING-CHANG LIU, SAN JOSE, CA (US); CHEN-RUI CHOU, SAN JOSE, CA (US); KO-KAI ALBERT HUANG, CUPERTINO, CA (US)

(21) Appl. No.: 14/816,250

(22) Filed: Aug. 3, 2015

Related U.S. Application Data
(60) Provisional application No. 62/126,758, filed on Mar. 2, 2015.

(51) Int. Cl. G06F 19/00; G06F 17/30

(52) U.S. Cl. CPC G06F 19/321; G06F 19/324; G06F 17/30858

(57) ABSTRACT

Various aspects of a method and system for content management of video images of anatomical regions are disclosed herein. In accordance with an embodiment of the disclosure, the method is implementable in a content processing device, which is communicatively coupled to an image-capturing device. The method includes identification of one or more non-tissue regions in a video image of an anatomical region. The video image is generated by the image-capturing device. Thereafter, one or more content identifiers are determined for the identified one or more non-tissue regions. Further, each of the determined one or more content identifiers are associated with a corresponding non-tissue region that corresponds to the identified one or more non-tissue regions.

### CROSS-REFERENCE TO RELATED APPLICATIONS/INCORPORATION BY REFERENCE

This application claims priority to U.S. Provisional Patent Application Ser. No. 62/126,758 filed on Mar. 2, 2015, the entire content of which is hereby incorporated by reference.

### FIELD

Various embodiments of the disclosure relate to content management. More specifically, various embodiments of the disclosure relate to content management of video images of anatomical regions.

### BACKGROUND

With recent advancements in the field of medical science, various surgical and diagnostic procedures can now be performed by use of minimally invasive techniques. Such minimally invasive techniques require small incisions to be made on a patient's skin. Through such small incisions, endoscopic and/or laparoscopic surgical tools may be inserted through the patient's skin into the body cavity. At least one of the endoscopic and/or laparoscopic tools includes an inbuilt camera to capture video images of the body cavity. The camera may enable a physician to navigate the endoscopic and/or laparoscopic surgical tools through the body cavity to reach an anatomical region on which the surgical or diagnostic procedure is to be performed. Other endoscopic and/or laparoscopic tools may perform the surgical operations on the tissues of the anatomical region.

Generally, surgical imagery is recorded when such surgical or diagnostic procedures are performed. The surgical imagery may include complicated surgical scenes with various ongoing activities, such as movement of surgical instruments and/or movement of gauze in and out of the view. In certain scenarios, unpredictable situations (such as tissues appearance, tissue motion, tissue deformation, sudden bleeding, and/or smoke emergence) in the complicated surgical scene compositions and during the ongoing activities may affect not only sensor image quality, but also surgical or diagnostic procedure efficiency. Hence, there is a need to understand the surgical imagery captured during the surgical or diagnostic procedure for surgical navigation assistance during the surgical or diagnostic procedure, and content management of the surgical imagery.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

A method and system for content management of video images of anatomical regions substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram that illustrates a network environment, in accordance with an embodiment of the disclosure.

FIG. 2 is a block diagram that illustrates an exemplary content management server, in accordance with an embodiment of the disclosure.

FIG. 3 is a block diagram that illustrates an exemplary user terminal, in accordance with an embodiment of the disclosure.

FIG. 4 illustrates an exemplary scenario of a user interface (UI) that may be presented on a user terminal, in accordance with an embodiment of the disclosure.

FIG. 5 is a flow chart that illustrates an exemplary method for content management of video images of anatomical regions, in accordance with an embodiment of the disclosure.

FIG. 6 is a first exemplary flow chart that illustrates a first exemplary method for content retrieval, in accordance with an embodiment of the disclosure.

FIG. 7 is a second exemplary flow chart that illustrates a second exemplary method for content retrieval, in accordance with an embodiment of the disclosure.

### DETAILED DESCRIPTION

The following described implementations may be found in disclosed method and system for content management of video images of anatomical regions. Exemplary aspects of the disclosure may include a method implementable in a content processing device, which is communicatively coupled to an image-capturing device. The method may include identification of one or more non-tissue regions in a video image of an anatomical region. The video image may be generated by the image-capturing device. Thereafter, one or more content identifiers may be determined for the identified one or more non-tissue regions. Further, each of the determined one or more content identifiers may be associated with a corresponding non-tissue region of the identified one or more non-tissue regions.

In accordance with an embodiment, the one or more non-tissue regions may include, but are not limited to, a smoke/mist region, a surgical instrument region, a surgical gauze region, or a blood region. In accordance with an embodiment, an index is generated for each identified non-tissue region in the video image, based on each determined content identifier associated with the corresponding non-tissue region.

In accordance with an embodiment, a query that comprises one or more search terms may be received. The one or more search terms may be associated with a first content identifier. In accordance with an embodiment, the first content identifier may be determined, based on the one or more search terms by use of a natural language processing technique or a text processing technique. Thereafter, one or more video image portions may be retrieved from the video image based on the first content identifier. The retrieved one or more video image portions may include at least a first non-tissue region from the identified non-tissue regions. The first non-tissue region may correspond to the first content identifier. In accordance with an embodiment, the retrieved one or more video portions may be displayed. In accordance with an embodiment, the first non-tissue region may be masked or highlighted within the displayed one or more video image portions. In accordance with an embodiment, the retrieved one or more video image portions may be displayed via a picture-in-picture interface or a picture-on-picture interface.

In accordance with an embodiment, a timestamp that corresponds to a video image that comprises a first video image portion, from the retrieved one or more video image portions, is displayed. The first video image portion may correspond to an occurrence of an event in the video image. Examples of the event may include, but are not limited to, an initial appearance of the first non-tissue region within the video images, a final appearance of the first non-tissue region within the video images, a proximity of the first non-tissue region with a tissue region, another proximity of the first non-tissue region with another non-tissue region of the one or more non-tissue regions. In accordance with an embodiment, in addition to the association with the first content identifier, the one or more search terms may be further associated with the occurred event.

In accordance with an embodiment, machine learning may be performed based on the identified one or more non-tissue regions, the determined one or more content identifiers, and the association of each of the determined one or more content identifiers that correspond to the non-tissue region.

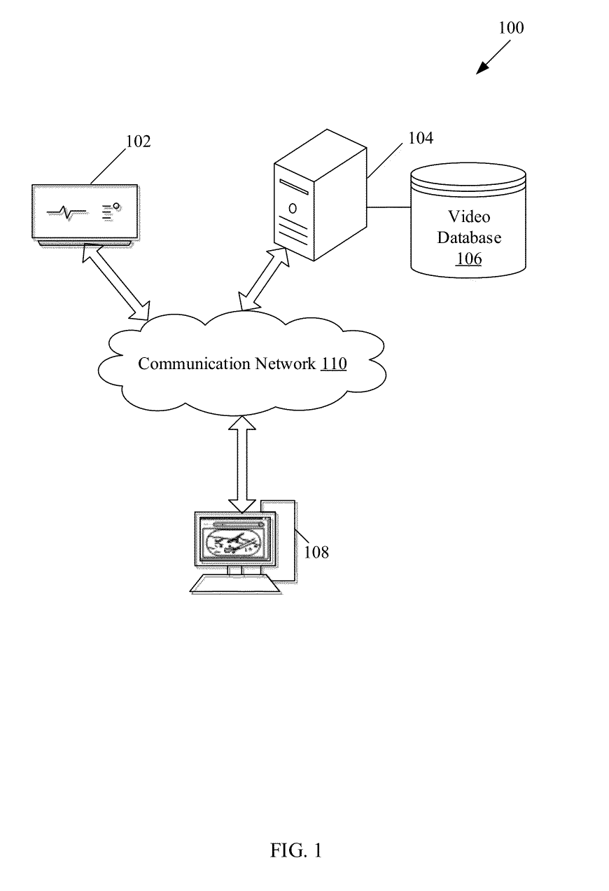

FIG. 1 is a block diagram that illustrates a network environment, in accordance with an embodiment of the disclosure. With reference to FIG. 1, there is shown a network environment 100. The network environment 100 may include a surgical device 102, a content management server 104, a video database 106, a user terminal 108, and a communication network 110. The surgical device 102 may be communicatively coupled with the content management server 104, the video database 106, and the user terminal 108, via the communication network 110.

The surgical device 102 may comprise suitable logic, circuitry, interfaces, and/or code that may be configured to perform one or more surgical procedures and/or diagnostic analysis associated with one or more anatomical regions of a patient. Examples of the surgical device 102 may include, but are not limited to, a minimally invasive surgical/diagnostic device, a minimally incisive surgical/diagnostic device, and/or an endoscopic/laparoscopic surgical/diagnostic device.

In accordance with an embodiment, the surgical device 102 may further include an image-capturing device (not shown in FIG. 1) to capture video images of an anatomical region of a patient. Alternatively, the surgical device 102 may be communicatively coupled to the image-capturing device, via the communication network 110. Examples of the image-capturing device may include, but are not limited to, an endoscopic/laparoscopic camera, a medical resonance imaging (MRI) device, a computer tomography (CT) scanning device, a minimally invasive medical imaging device, and/or a minimally incisive medical imaging device.

The content management server 104 may comprise one or more servers that may provide an anatomical content management service to one or more subscribed electronic devices, such as the user terminal 108 and/or the surgical device 102. In accordance with an embodiment, the one or more servers may be implemented as a plurality of cloud-based resources by use of several technologies that are well known to those skilled in the art. Further, the one or more servers may be associated with single or multiple service providers. Examples of the one or more servers may include, but are not limited to, Apache™ HTTP Server, Microsoft® Internet Information Services (IIS), IBM® Application Server, Sun Java™ System Web Server, and/or a file server.

A person having ordinary skill in the art may understand that the scope of the disclosure is not limited to implementation of the content management server 104 and the surgical device 102 as separate entities. In accordance with an embodiment, the functionalities of the content management server 104 may be implemented by the surgical device 102, without departure from the scope of the disclosure.

The video database 106 may store a repository of video images of surgical or diagnostic procedures performed on one or more anatomical regions of one or more patients. In accordance with an embodiment, the video database 106 may be communicatively coupled to the content management server 104. The video database 106 may receive the video images, which may be captured by the image-capturing device, via the content management server 104. In accordance with an embodiment, the video database 106 may be implemented by use of various database technologies known in the art. Examples of the video database 106 may include, but are not limited to, Microsoft® SQL Server, Oracle®, IBM DB2®, Microsoft Access®, PostgreSQL®, MySQL®, SQLite®, and/or the like. In accordance with an embodiment, the content management server 104 may connect to the video database 106, based on one or more protocols. Examples of such one or more protocols may include, but are not limited to, Open Database Connectivity (ODBC)® protocol and Java Database Connectivity (JDBC)® protocol.

A person having ordinary skill in the art will understand that the scope of the disclosure is not limited to implementation of the content management server 104 and the video database 106 as separate entities. In accordance with an embodiment, the functionalities of the video database 106 may be implemented by the content management server 104, without departure from the scope of the disclosure.

The user terminal 108 may comprise suitable logic, circuitry, interfaces, and/or code that may be configured to present a user interface (UI) for content management to a user, such as a physician. Examples of the user terminal 108 may include, but are not limited to, a smartphone, a camera, a tablet computer, a laptop, a wearable electronic device, a television, an Internet Protocol Television (IPTV), and/or a Personal Digital Assistant (PDA) device.

A person having ordinary skill in the art may understand that the scope of the disclosure is not limited to implementation of the user terminal 108 and the content management server 104 as separate entities. In accordance with an embodiment, the functionalities of the content management server 104 may be implemented by the user terminal 108, without departure from the spirit of the disclosure. For example, the content management server 104 may be implemented as an application program that runs and/or is installed on the user terminal 108.

A person skilled in the art may further understand that in accordance with an embodiment, the user terminal 108 may be integrated with the surgical device 102. Alternatively, the user terminal 108 may be communicatively coupled to the surgical device 102 and a user of the user terminal 108, such as a physician, may control the surgical device 102 via a UI of the user terminal 108.

The communication network 110 may include a medium through which the surgical device 102 and/or the user terminal 108 may communicate with one or more servers, such as the content management server 104. Examples of the communication network 110 may include, but are not limited to, the Internet, a cloud network, a Wireless Fidelity (Wi-Fi) network, a Wireless Local Area Network (WLAN), a Local Area Network (LAN), a plain old telephone service (POTS), and/or a Metropolitan Area Network (MAN). Various devices in the network environment 100 may be configured to connect to the communication network 110, in accordance with various wired and wireless communication protocols. Examples of such wired and wireless communication protocols may include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, cellular communication protocols, and/or Bluetooth (BT) communication protocols.

In operation, the content management server 104 may be configured to identify one or more non-tissue regions in each video image of the anatomical region. The identification of the one or more non-tissue regions in each video image may be performed based on one or more object recognition algorithms, known in the art.

The content management server 104 may be further configured to determine one or more content identifiers for the identified one or more non-tissue regions in the video image. Thereafter, the content management server 104 may associate each of the determined one or more content identifiers with a corresponding non-tissue region of the identified one or more non-tissue regions. In accordance with an embodiment, the one or more non-tissue regions may include, but are not limited to, a smoke/mist region, a surgical instrument region, a surgical gauze region, or a blood region. In accordance with an embodiment, the content management server 104 may be configured to generate an index for each identified non-tissue region in the video image, based on each determined content identifier associated with the corresponding non-tissue region. The indexed one or more non-tissue regions in the video images may be stored in the video database 106, for later retrieval.

In accordance with an embodiment, the content management server 104 may be configured to receive a query from the user terminal 108. The query may comprise one or more search terms. The one or more search terms may be associated with a first content identifier. In accordance with an embodiment, the content management server 104 may be configured to determine the first content identifier, based on the one or more search terms, by use of a natural language processing technique or a text processing technique.

Thereafter, the content management server 104 may retrieve one or more video image portions from the video image, based on the first content identifier. The retrieved one or more video image portions may include at least a first non-tissue region that corresponds to the first content identifier. In accordance with an embodiment, the content management server 104 may be configured to display the retrieved one or more video portions at the user terminal for the physician, via a UI of the user terminal 108. In accordance with an embodiment, the content management server 104 may mask or highlight the first non-tissue region within the displayed one or more video image portions. In accordance with an embodiment, the retrieved one or more video image portions may be displayed via a picture-in-picture interface or a picture-on-picture interface.

In accordance with an embodiment, the content management server 104 may be configured to display a timestamp that corresponds to a desired video image from the one or more video images. Such video image may comprise a first video image portion from the retrieved one or more video image portions. The first video image portion may correspond to an occurrence of an event in the video image. Examples of the event may include, but are not limited to, an initial appearance of the first non-tissue region within the video images, a final appearance of the first non-tissue region within the video images, a proximity of the first non-tissue region with a tissue region, another proximity of the first non-tissue region with another non-tissue region of the one or more non-tissue regions. In accordance with an embodiment, in addition to the association with the first content identifier, the one or more search terms may be further associated with the occurred event. Such an association of the first content identifier and the one or more search terms with the occurred event may provide one or more surgical navigation assistance, such as bleeding localization (to identify the location and source of blood stains), smoke evacuation and lens cleaning trigger (to improve visibility in case smoke and/or mist appears in the surgical region), surgical tool warnings (to determine proximity distance of surgical tools from tissue regions), and/or gauze and/or surgical tool tracking (to auto-check for clearance of the gauzes and/or surgical tools from the anatomical regions).

In accordance with an embodiment, the content management server 104 may be further configured to perform machine learning based on the identified one or more non-tissue regions, the determined one or more content identifiers, and the association of each of the determined one or more content identifiers with the corresponding non-tissue region. Based on the machine learning performed by the content management server 104, the content management server 104 may be configured to associate each of the one or more content identifiers with a corresponding non-tissue region in new video images of the one or more anatomical regions.

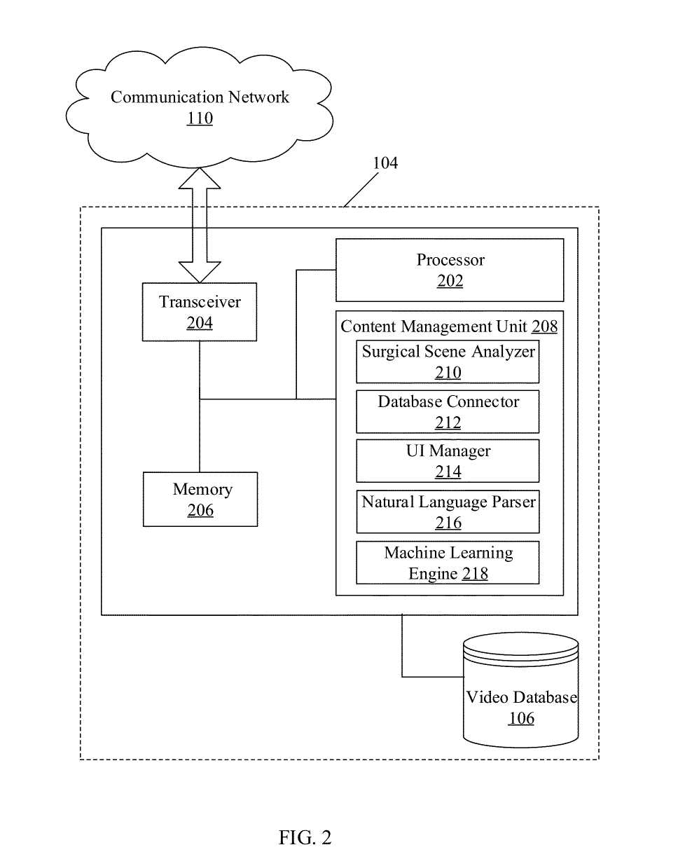

FIG. 2 is a block diagram that illustrates an exemplary content management server, in accordance with an embodiment of the disclosure. FIG. 2 is explained in conjunction with elements from FIG. 1. With reference to FIG. 2, there is shown the content management server 104. The content management server 104 may comprise one or more processors, such as a processor 202, one or more transceivers, such as a transceiver 204, a memory 206, and a content management unit 208. The content management unit 208 may include a surgical scene analyzer 210, a database connector 212, a UI manager 214, a natural language parser 216, and a machine learning engine 218. In accordance with an embodiment, the content management server 104 may be communicatively coupled to the video database 106 through the communication network 110, via the transceiver 204. Alternatively, the content management server 104 may include the video database 106. For example, the video database 106 may be implemented within the memory 206.

The processor 202 may be communicatively coupled to the transceiver 204, the memory 206, and the content management unit 208. The transceiver 204 may be configured to communicate with the surgical device 102 and the user terminal 108, via the communication network 110.

The processor 202 may comprise suitable logic, circuitry, interfaces, and/or code that may be configured to execute a set of instructions stored in the memory 206. The processor 202 may be implemented based on a number of processor technologies known in the art. Examples of the processor 202 may be an X86-based processor, a Reduced Instruction Set Computing (RISC) processor, an Application-Specific Integrated Circuit (ASIC) processor, a Complex Instruction Set Computing (CISC) processor, and/or other processors.

The transceiver 204 may comprise suitable logic, circuitry, interfaces, and/or code that may be configured to communicate with the user terminal 108 and/or the surgical device 102, via the communication network 110 (as shown in FIG. 1). The transceiver 204 may implement known technologies to support wired or wireless communication of the content management server 104 with the communication network 110. The transceiver 204 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, and/or a local buffer.

The transceiver 204 may communicate, via wireless communication, with networks, such as the Internet, an Intranet and/or a wireless network, such as a cellular telephone network, a wireless local area network (LAN) and/or a metropolitan area network (MAN). The wireless communication may use any of a plurality of communication standards, protocols and technologies, such as Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (such as IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS).

The memory 206 may comprise suitable logic, circuitry, and/or interfaces that may be configured to store a machine code and/or a computer program with at least one code section executable by the processor 202. In accordance with an embodiment, the memory 206 may be further configured to store video images captured by the image-capturing device. The memory 206 may store one or more content identifiers associated with one or more non-tissue regions in the video images. The one or more content identifiers may be determined, based on an analysis of the one or more video images. Alternatively, the one or more content identifiers may be predetermined and pre-stored in the memory 206. Examples of implementation of the memory 206 may include, but are not limited to, Random Access Memory (RAM), Read Only Memory (ROM), Hard Disk Drive (HDD), and/or a Secure Digital (SD) card.

The content management unit 208 may comprise suitable logic, circuitry, interfaces, and/or code that may be configured to perform anatomical content management. The anatomical content may include the video images captured by the image-capturing device. In accordance with an embodiment, the content management unit 208 may be a part of the processor 202. Alternatively, the content management unit 208 may be implemented as a separate processor or circuitry in the content management server 104. In accordance with an embodiment, the content management unit 208 and the processor 202 may be implemented as an integrated processor or a cluster of processors that performs the functions of the content management unit 208 and the processor 202. In accordance with an embodiment, the content management unit 208 may be implemented as a computer program code, stored in the memory 206, which on execution by the processor 202, may perform the functions of the content management unit 208.

The surgical scene analyzer 210 may comprise suitable logic, circuitry, interfaces, and/or code that may be configured to perform one or more image-processing operations to analyze the video images captured by the image-capturing device. In accordance with an embodiment, the video images may include an anatomical region of a patient on which a surgical or diagnostic procedure is performed by use of the surgical device 102. Based on the analysis of the video images, the surgical scene analyzer 210 may identify one or more non-tissue regions in each video image. In accordance with an embodiment, the one or more non-tissue regions may include, but are not limited to, a smoke/mist region, a surgical instrument region, a surgical gauze region, or a blood region. In accordance with an embodiment, the surgical scene analyzer 210 may determine one or more content identifiers for the identified one or more non-tissue regions in each video image. Alternatively, the one or more content identifiers may be pre-stored in the memory 206. In such a scenario, the one or more content identifiers need not be determined by the surgical scene analyzer 210. Further, in accordance with an embodiment, the surgical scene analyzer 210 may associate each of the one or more content identifiers with a corresponding non-tissue region of the identified one or more non-tissue regions in each video image.

The database connector 212 may comprise suitable logic, circuitry, interfaces, and/or code that may be configured to provide the content management unit 208 with access and connectivity to the video database 106. In accordance with an embodiment, the database connector 212 may establish a database session between the content management unit 208 and the video database 106. Examples of one or more communication protocols used for establishing the database session may include, but are not limited to, Open Database Connectivity (ODBC) protocol and Java Database Connectivity (JDBC) protocol.

In accordance with an embodiment, the database connector 212 may include an indexing engine (not shown in FIG. 2) that may be configured to perform indexing of the analyzed video images in the video database 106. Such an indexing of the video images may enable efficient search and retrieval of the video images for non-tissue regions, based on the content identifier assigned to respective non-tissue region. A person having ordinary skill in the art may understand that the scope of the disclosure is not limited to the database connector 212 to implement the functionality of the indexing engine. In accordance with an embodiment, the indexing engine may be a part of the surgical scene analyzer 210. In accordance with an embodiment, the indexing engine may be implemented as an independent module within the content management unit 208. The indexing engine may be configured to generate an index for each of the identified one or more non-tissue regions in the video images based on the one or more content identifiers associated with each corresponding non-tissue region. The indexed video images may be stored in the video database 106 for later retrieval.

The UI manager 214 may comprise suitable logic, circuitry, interfaces, and/or code that may be configured to manage a UI presented on the user terminal 108. In accordance with an embodiment, the UI manager 214 may provide a search interface to a user (such as a physician) of the user terminal 108. The search interface may be presented to the user on a display device of the user terminal 108, via a UI of the user terminal 108. The user may provide a query that includes one or more search terms through the search interface. Based on the one or more search terms, the UI manager 214 may retrieve one or more video image portions from the indexed video images stored in the video database 106. In accordance with an embodiment, the UI manager 214 may generate a result interface that includes the retrieved one or more video image portions. The UI manager 214 may present the result interface on the display device of the user terminal 108, via the UI of the user terminal 108.

The natural language parser 216 may comprise suitable logic, circuitry, interfaces, and/or code that may be configured to analyze the one or more search terms received from the user of the user terminal 108 (through the search interface). In accordance with an embodiment, the natural language parser 216 may analyze the one or more search terms by use of one or more natural language processing techniques and/or text processing techniques. The natural language parser 216 may perform a semantic association of the first content identifier that correspond to one of the search terms with one or more content identifiers, pre-stored in the memory 206 and/or the video database 106. Examples of the one or more natural language processing and/or text processing techniques may include, but are not limited to, Naïve Bayes classification, artificial neural networks, Support Vector Machines (SVM), multinomial logistic regression, or Gaussian Mixture Model (GMM) with Maximum Likelihood Estimation (MLE). Based on the analysis of the one or more search terms, the natural language parser 216 may determine a first content identifier that corresponds to the one or more search terms. In accordance with an embodiment, the first content identifier may correspond to at least one content identifier of the one or more content identifiers.

The machine learning engine 218 may comprise suitable logic, circuitry, and/or interfaces that may be configured to implement artificial intelligence to learn from data stored in the memory 206 and/or the video database 106. The machine learning engine 218 may be further configured to retrieve data from the memory 206 and/or the video database 106. Such data may correspond to historical data of association of the one or more content identifiers to one or more corresponding non-tissue regions in the one or more video images. The machine learning engine 218 may be configured to analyze the historical data and recognize one or more patterns from the historical data. In accordance with an embodiment, based on recognized patterns, the machine learning engine 218 may be configured to generate one or more rules and store the generated one or more rules in the memory 206 and/or the video database 106. In accordance with an embodiment, the surgical scene analyzer 210 may be configured to retrieve the one or more rules and analyze new video images based on the one or more rules. For example, the surgical scene analyzer 210 may employ the one or more rules to associate each of the one or more content identifiers to corresponding non-tissue regions in new video images. The machine learning engine 218 may be implemented based on one or more approaches, such as, an Artificial Neural Network (ANN), an inductive logic programming approach, a Support Vector Machine (SVM), an association rule learning approach, a decision tree learning approach, and/or a Bayesian network. Notwithstanding, the disclosure may not be so limited, and any suitable learning approach may be utilized without limiting the scope of the disclosure.

In operation, a physician may perform a surgical or diagnostic procedure on an anatomical region of a patient by use of the surgical device 102 and one or more surgical instruments. Examples of the one or more surgical instruments may include, but are not limited to, endoscopic catheters, surgical forceps, surgical incision instruments, and/or surgical gauzes. Examples of the surgical or diagnostic procedures may include, but are not limited to, a minimally invasive surgery/diagnosis procedure, a minimally incisive surgery/diagnosis procedure, a laparoscopic procedure, and/or an endoscopic procedure. In accordance with an embodiment, the surgical or diagnostic procedure may be automated and performed by a surgical robot, without any supervision or direction from the physician. In accordance with an embodiment, the surgical or diagnostic procedure may be semi-automated and performed by the surgical robot, with one or more input signals and/or commands from the physician. In accordance with an embodiment, the image-capturing device (not shown in FIG. 1) may be communicatively coupled to (or included within) the surgical device 102. The image-capturing device may capture one or more video images of the anatomical region, while the surgical or diagnostic procedure is performed on the anatomical region. Thereafter, the surgical device 102 (or the image-capturing device itself) may transmit the captured one or more video images to the content management server 104, via the communication network 110.

The transceiver 204 in the content management server 104 may be configured to receive the one or more video images of the anatomical region from the surgical device 102, via the communication network 110. The database connector 212 may be configured to establish a database session with the video database 106 and store the received one or more video images in the video database 106. Further, the one or more video images may also be stored in the memory 206.

The surgical scene analyzer 210 may be configured to analyze the one or more video images. In accordance with an embodiment, the one or more video images may be analyzed in a batch-mode (offline processing), when a predetermined number of video images are received from the surgical device 102. In accordance with an embodiment, the one or more video images may be analyzed on a real-time basis (online processing), upon receipt of every new video image. The surgical scene analyzer 210 may retrieve the one or more video images from the memory 206 and/or the video database 106, to analyze the one or more video images. Thereafter, the surgical scene analyzer 210 may be configured to identify the one or more non-tissue regions in each video image. Examples of the one or more non-tissue regions include, but are not limited to, a smoke/mist region, a surgical instrument region, a surgical gauze region, or a blood region.

In accordance with an embodiment, the surgical scene analyzer 210 may be configured to determine the one or more content identifiers for the identified one or more non-tissue regions. In accordance with an embodiment, the one or more content identifiers may be predetermined by a physician and pre-stored in the memory 206 and/or the video database 106. In such a case, the surgical scene analyzer 210 need not determine the one or more content identifiers. The surgical scene analyzer 210 may retrieve the one or more content identifiers from the memory 206 and/or the video database 106.

Thereafter, the surgical scene analyzer 210 may associate each of the one or more content identifiers with a corresponding non-tissue region from the identified one or more non-tissue regions. In accordance with an embodiment, the indexing engine (not shown in FIG. 2) may be configured to generate an index for each of the identified one or more non-tissue regions in the video images, based on the one or more content identifiers associated with each corresponding non-tissue region. In accordance with an embodiment, the indexed video images may be stored in the video database 106 for later retrieval.

In accordance with an embodiment, the surgical scene analyzer 210 may be further configured to provide a feedback associated with the captured video images to the image-capturing device, when the video images are analyzed on a real-time basis (in an online processing mode). For example, the surgical scene analyzer 210 may perform masking of the one or more non-tissue regions in the video images in real-time. Thereafter, the surgical scene analyzer 210 may transmit information associated with the masked one or more non-tissue regions to the image-capturing device, via the transceiver 204. The image-capturing device may perform real-time adjustments of its auto exposure and/or auto focus settings, based on the information associated with the masked one or more non-tissue regions.

In accordance with an embodiment, the surgical scene analyzer 210 may be further configured to determine optimal camera parameters for the image-capturing device, during real-time or online analysis of the video images. Examples of the camera parameters may include, but are not limited to, auto exposure, auto focus, auto white balance, and/or auto illumination control. In accordance with an embodiment, the surgical scene analyzer 210 may determine the optimal camera parameters for specific scenes in the video images. For example, video images with more than a certain number of blood regions or smoke regions may require an adjustment of the camera parameters. Hence, the surgical scene analyzer 210 may determine the optimal camera parameters for such video image scenes. The surgical scene analyzer 210 may transmit the determined optimal camera parameters to the image-capturing device, via the transceiver 204. The image-capturing device may perform real-time adjustments of its camera parameters in accordance with the optimal camera parameters received from the surgical scene analyzer 210.

In accordance with an embodiment, the surgical scene analyzer 210 may be further configured to enhance image quality of the video images, based on the analysis of the video images. For example, the surgical scene analyzer 210 may detect one or more smoke regions in the video images during the identification of the one or more non-tissue regions in the video images. The surgical scene analyzer 210 may perform one or more image enhancement operations on such smoke regions to enhance the image quality of the video images.

The UI manager 214 may be configured to present a search interface on the display device of the user terminal 108. Through the search interface, the user, such as a physician, may provide a query to search for video image portions that are of interest to the user. The video image portions may be selected from the one or more video images of the anatomical region of the patient. The query may include one or more search terms associated with a first content identifier. The UI manager 214 may receive the query from the user terminal 108, via the transceiver 204. Thereafter, the natural language parser 216 may be configured to analyze the one or more search terms by use of one or more natural language processing and/or text processing techniques. Based on the analysis of the one or more search terms, the natural language parser 216 may determine the first content identifier.

In accordance with an embodiment, the natural language parser 216, in conjunction with the processor 202, may compare the determined first content identifier with the one or more content identifiers stored in the video database 106. The natural language parser 216, in conjunction with the processor 202, may further determine a similarity score between the determined first content identifier with each of the one or more content identifiers. The similarity score may be determined based on semantic analysis of the first content identifier with respect to the one or more content identifiers. The natural language parser 216 may select a content identifier from the one or more content identifiers, based on the similarity score that exceeds a threshold value. For instance, the natural language parser 216 may select a synonym of the first content identifier from the one or more content identifiers, based on the similarity score. Thereafter, the natural language parser 216 may update the first content identifier based on the selected content identifier from the one or more content identifiers.

In accordance with an embodiment, the UI manager 214 may access the video database 106, to retrieve the one or more video image portions from the one or more video images indexed and stored in the video database 106. The retrieved one or more video image portions may include a first non-tissue region from the one or more non-tissue regions identified in the one or more video images. The surgical scene analyzer 210 may associate and tag the first non-tissue region with the first content identifier.

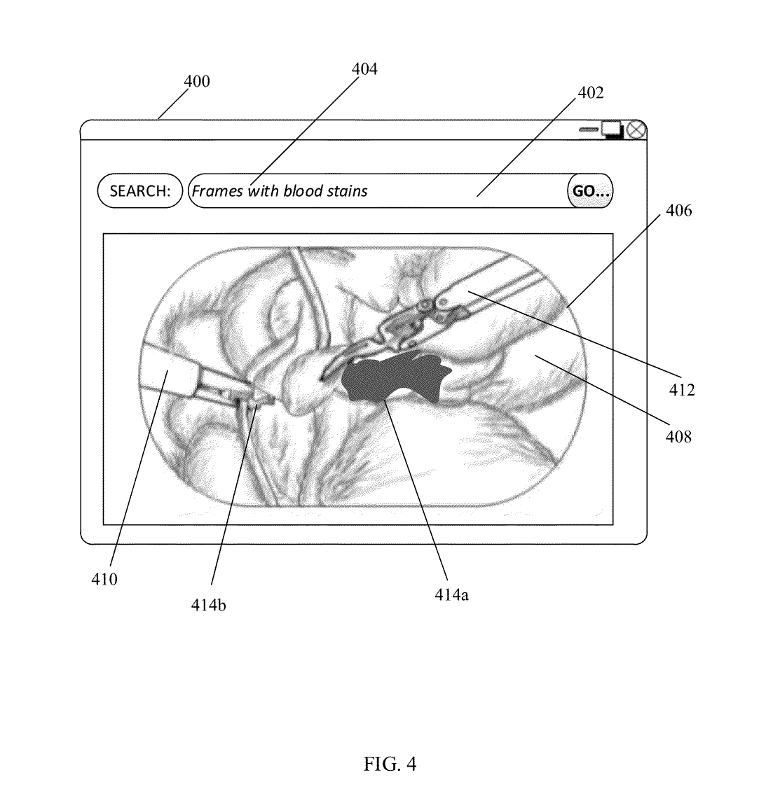

The UI manager 214 may generate a result interface to display the one or more video image portions associated with the first content identifier. The UI manager 214 may present the result interface to the user through the UI of the user terminal 108. In accordance with an embodiment, the UI manager 214 may mask or highlight the first non-tissue region in the one or more video image portions displayed within the result interface. In accordance with an embodiment, the UI manager 214 may display the first non-tissue region within the result interface as a picture-in-picture interface or a picture-on-picture interface. An example of the result interface has been explained in FIG. 4.

In accordance with an embodiment, a timestamp may be associated with an occurrence of an event in the one or more video images, in addition to the association with the first content identifier. Examples of the event may include, but are not limited to, an initial appearance of the first non-tissue region within the one or more video images, a final appearance of the first non-tissue region within the one or more video images, a proximity of the first non-tissue region with a tissue region, and/or another proximity of the first non-tissue region with another non-tissue region of the one or more non-tissue regions. In accordance with an embodiment, the surgical scene analyzer 210 may be configured to determine the timestamp that corresponds to a desired video image from the one or more video images. The desired video image may comprise a first video image portion from the retrieved one or more video image portions.

The first video image portion may correspond to the occurrence of the specified event. In accordance with an embodiment, the timestamp may be predetermined and pre-stored in the memory 206, and/or the video database 106, by the surgical scene analyzer 210. In such a case, while the one or more video images are analyzed, the surgical scene analyzer 210 may identify a set of video image portions in the one or more video images that correspond to a certain event. Thereafter, the surgical scene analyzer 210 may determine respective timestamps associated with such video images that include at least one of the video image portions from the identified set of video image portions.

In accordance with an embodiment, the indexing engine may be configured to index the one or more video images in the video database 106, based on the respective timestamps associated with such video images. Therefore, in such a case, the timestamp of the desired video image need not be determined on receipt of the query from the user. Instead, the UI manager 214 may be configured to retrieve the timestamp of the desired video image from the memory 206 and/or the video database 106 based on the one or more search terms in the query. In accordance with an embodiment, the UI manager 214 may be configured to display the timestamp of the desired video image within the result interface. Thereafter, the UI manager 214 may display the first video image portion within the result interface, when the user of the user terminal 108 provides an input to navigate to the desired video image that corresponds to the timestamp.

In accordance with an embodiment, the machine learning engine 218 may be configured to retrieve historical data from the memory 206 and/or the video database 106. The historical data may include metadata that may correspond to one or more previous video images analyzed by the surgical scene analyzer 210.

In accordance with an embodiment, the surgical scene analyzer 210 may generate the metadata associated with the video images after the analysis of the respective video images. The surgical scene analyzer 210 may be further configured to store the metadata in the memory 206 and/or the video database 106. The metadata of the video images may include information related to the one or more non-tissue regions identified in the video images. Examples of the information related to the one or more non-tissue regions may include, but are not limited to, a shape of a non-tissue region, a color of the non-tissue region, a texture of the non-tissue region, one or more features or characteristics of the non-tissue region, and/or a connectivity associated with the non-tissue region. In accordance with an embodiment, the metadata of the video images may further include information related to the one or more content identifiers determined for the one or more non-tissue regions in the video images. Examples of the information related to the one or more content identifiers may include, but are not limited to, a list of the one or more content identifiers and/or a list of key terms associated with each content identifier. In accordance with an embodiment, the metadata of the video images may further include information related to an association of each of the one or more content identifiers with a corresponding non-tissue region in the video images.

Based on the metadata of the one or more previous video images, the machine learning engine 218 may utilize machine learning techniques to recognize one or more patterns. Thereafter, in accordance with an embodiment, based on recognized patterns, the machine learning engine 218 may be configured to generate one or more facts related to the video images and store the generated one or more facts in the memory 206 and/or the video database 106. The machine learning engine 218 generates the one or more facts based on one or more rules pre-stored in the memory 206 and/or the video database 106. Examples of the one or more rules may include, but are not limited to, Fuzzy Logic rules, Finite State Automata (FSM) rules, Support Vector Machine (SVM) rules, and/or artificial neural network (ANN) rules. In accordance with an embodiment, the surgical scene analyzer 210 may be configured to retrieve the one or more rules and analyze new video images based on the one or more rules. For example, the surgical scene analyzer 210 may employ the one or more rules to associate each of the one or more content identifiers to corresponding non-tissue regions in new video images.

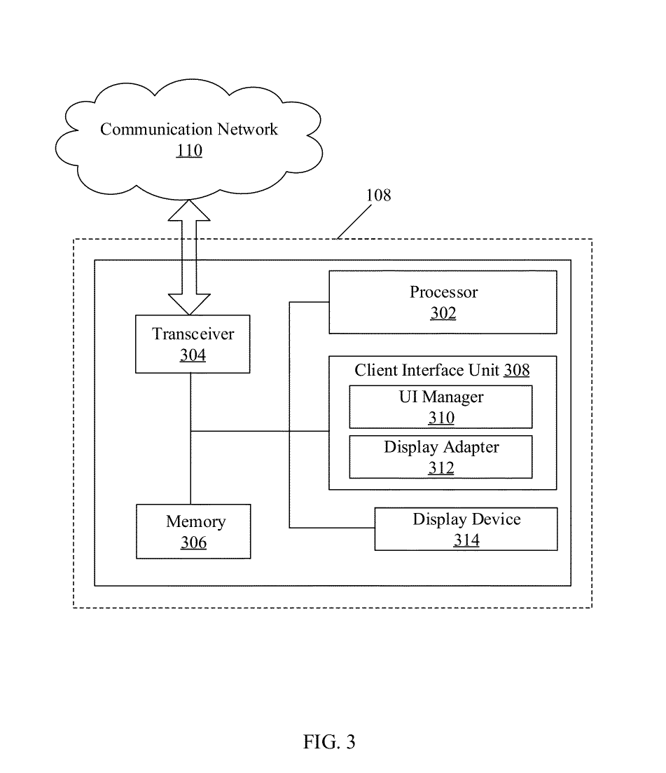

FIG. 3 is a block diagram that illustrates an exemplary user terminal, in accordance with an embodiment of the disclosure. FIG. 3 is explained in conjunction with elements from FIG. 1. With reference to FIG. 3, there is shown the user terminal 108. The user terminal 108 may comprise one or more processors, such as a processor 302, one or more transceivers, such as a transceiver 304, a memory 306, a client interface unit 308, and a display device 314. The client interface unit 308 may include a UI manager 310 and a display adapter 312.

The processor 302 may be communicatively coupled to the transceiver 304, the memory 306, the client interface unit 308, and the display device 314. The transceiver 304 may be configured to communicate with the content management server 104, via the communication network 110.

The processor 302 may comprise suitable logic, circuitry, interfaces, and/or code that may be configured to execute a set of instructions stored in the memory 306. The processor 302 may be implemented based on a number of processor technologies known in the art. Examples of the processor 302 may be an X86-based processor, a Reduced Instruction Set Computing (RISC) processor, an Application-Specific Integrated Circuit (ASIC) processor, a Complex Instruction Set Computing (CISC) processor, and/or other processors.

The transceiver 304 may comprise suitable logic, circuitry, interfaces, and/or code that may be configured to communicate with the content management server 104, via the communication network 110. The transceiver 304 may implement known technologies to support wired or wireless communication of the user terminal 108 with the communication network 110. The transceiver 304 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, and/or a local buffer.

The transceiver 304 may communicate via wireless communication with networks, such as the Internet, an Intranet and/or a wireless network, such as a cellular telephone network, a wireless local area network (LAN) and/or a metropolitan area network (MAN). The wireless communication may use any of a plurality of communication standards, protocols and technologies, such as Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (such as IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS).

The memory 306 may comprise suitable logic, circuitry, and/or interfaces that may be configured to store a machine code and/or a computer program with at least one code section executable by the processor 302. Examples of implementation of the memory 306 may include, but are not limited to, Random Access Memory (RAM), Read Only Memory (ROM), Hard Disk Drive (HDD), and/or a Secure Digital (SD) card.

The client interface unit 308 may comprise suitable logic, circuitry, interfaces, and/or code that may be configured to perform rendering and management of one or more UIs presented on the user terminal 108. In accordance with an embodiment, the client interface unit 308 may be a part of the processor 302. Alternatively, the client interface unit 308 may be implemented as a separate processor or circuitry in the user terminal 108. For example, the client interface unit 308 may be implemented as a dedicated graphics processor or chipset, communicatively coupled to the processor 302. In accordance with an embodiment, the client interface unit 308 and the processor 302 may be implemented as an integrated processor or a cluster of processors that perform the functions of the client interface unit 308 and the processor 302. In accordance with an embodiment, the client interface unit 308 may be implemented as a computer program code, stored in the memory 306, which on execution by the processor 302 may perform the functions of the client interface unit 308.

The UI manager 310 may comprise suitable logic, circuitry, interfaces, and/or code that may be configured to manage the UI of the user terminal 108. The UI manager 310 may be configured to receive and process user-input received through the UI of the user terminal 108, via an input device (not shown in FIG. 3) of the user terminal 108. The input device may be communicatively coupled to (or included within) the user terminal 108. Examples of the input device may include, but are not limited to, a keyboard, a mouse, a joy stick, a track pad, a voice-enabled input device, a touch-enabled input device, and/or a gesture-enabled input device.

In accordance with an embodiment, the UI manager 310 may be further configured to communicate with the UI manager 214 of the content management server 104, via the transceiver 304. Such communication may facilitate receipt of information that corresponds to the search interface. Thereafter, the UI manager 310 may present the search interface through the UI of the user terminal 108. The UI manager 310 may be further configured to receive an input from the user through the UI, via the input device. For example, the user may enter one or more search terms through a search bar in the search interface. The UI manager 310 may transmit the user input, such as the one or more search terms, to the UI manager 214 of the content management server 104, via the transceiver 304. In accordance with an embodiment, the UI manager 310 may be further configured to receive information that may correspond to the result interface from the UI manager 214 of the content management server 104, via the transceiver 304. Thereafter, the UI manager 310 may present the result interface to the user through the UI of the user terminal 108.

The display adapter 312 may comprise suitable logic, circuitry, interfaces, and/or code that may be configured to interface the UI manager 310 with the display device 314. In accordance with an embodiment, the display adapter 312 may perform an adjustment of rendering and display properties of the UI of the user terminal 108, based on display configurations of the display device 314. Examples of one or more techniques that may be employed to perform the display adjustment may include, but are not limited to, image enhancement, image stabilization, contrast adjustment, brightness adjustment, resolution adjustment, and/or skew/rotation adjustment.

The display device 314 may comprise suitable logic, circuitry, interfaces, and/or code that may be configured to render the UI of the user terminal 108. In accordance with an embodiment, the display device 314 may be implemented as a part of the user terminal 108. In accordance with an embodiment, the display device 314 may be communicatively coupled to the user terminal 108. The display device 314 may be realized through several known technologies such as, but not limited to, Cathode Ray Tube (CRT) based display, Liquid Crystal Display (LCD), Light Emitting Diode (LED) based display, Organic LED display technology, and Retina display technology. In accordance with an embodiment, the display device 314 may be capable of receiving input from the user. In such a scenario, the display device 314 may be a touch screen that enables the user to provide the input. The touch screen may correspond to at least one of a resistive touch screen, a capacitive touch screen, or a thermal touch screen. In accordance with an embodiment, the display device 314 may receive the input through a virtual keypad, a stylus, a gesture-based input, and/or a touch-based input. In such a case, the input device may be integrated within the display device 314. In accordance with an embodiment, the user terminal 108 may include a secondary input device apart from a touch screen based display device 314.

In operation, the transceiver 304 of the user terminal 108 may receive information that may correspond to a search interface from the UI manager 214 of the content management server 104, via the communication network 110. Thereafter, in accordance with an embodiment, the UI manager 310 of the user terminal 108 may present the search interface to the user, through the UI of the user terminal 108. In accordance with an embodiment, the search interface may include a search bar that may prompt the user to enter a search query. The user may provide the search query by entering one or more search terms in the search bar through the UI. In accordance with an embodiment, the search interface may suggest a list of search terms to the user. For example, the search interface may provide a list frequently queried search terms. Further, the search interface may provide the user with an auto-complete functionality. For example, the search interface may automatically complete or fill-in the search query while the user enters the one or more search terms of the search query. In accordance with an embodiment, the UI manager 310 may further be configured to receive the search query provided by the user through the UI of the user terminal 108, via the input device (not shown in FIG. 3) of the user terminal 108. In accordance with an embodiment, the one or more search terms in the search query may be a first content identifier. In accordance with an embodiment, the UI manager 310 may be further configured to transmit the received search query, which may include the one or more search terms, to the UI manager 214 of the content management server 104, via the transceiver 304.

In accordance with an embodiment, the UI manager 310 may be further configured to receive information that may correspond to a result interface from the UI manager 214 of the content management server 104, via the transceiver 304. Further, the UI manager 310 may be configured to present the result interface to the user on the user terminal 108, via the UI of the user terminal 108. In accordance with an embodiment, the result interface may include one or more video image portions, which are retrieved from the one or more video images by the content management server 104, based on the first content identifier. The one or more video image portions may include a first non-tissue region associated with the first content identifier. In accordance with an embodiment, the first non-tissue region may be masked or highlighted within the one or more video image portions displayed in the result interface. The result interface may display the one or more video image portions, which may include the first non-tissue region, via a picture-in-picture interface or a picture-on-picture interface.

In accordance with an embodiment, the one or more search terms may be further associated with an occurrence of an event in the one or more video images, in addition to an association with the first content identifier. In such a scenario, the result interface may display a timestamp that corresponds to a desired video image, from the one or more video images, which comprises a first video image portion of the one or more video image portions. In accordance with an embodiment, the first video image portion may correspond to the occurrence of the event in the one or more video images. Examples of the event may include, but are not limited to, an initial appearance of the first non-tissue region within the video images, a final appearance of the first non-tissue region within the video images, a proximity of the first non-tissue region with a tissue region, and/or another proximity of the first non-tissue region with another non-tissue region of the one or more non-tissue regions. In accordance with an embodiment, when the user provides an input to navigate to the timestamp, the UI manager 310 may display the desired video image, which may include the first video image portion, through the UI of the user terminal 108.

In accordance with an embodiment, the result interface may also include the search bar associated with the search interface. In accordance with an embodiment, the result interface may further include a search history portion, which may display a list of search queries previously provided by the user. In such a scenario, the result interface may be used in a manner similar to the search interface to perform further search or refine previous searches on the one or more video images. An example of the result interface has been explained in FIG. 4.

In accordance with an embodiment, the result interface may be further configured to enable the user to view the one or more video images. For example, the result interface may provide the user with an option to view one or more portions of a video image selected by the user, or the one or more video images in their entirety. In accordance with an embodiment, the result interface may mask or highlight each non-tissue region in the one or more video images, while the one or more video images are displayed to the user. Further, the result interface may also display the corresponding content identifiers associated with each such non-tissue region, simultaneously, as that non-tissue region appears in the one or more video images being displayed to the user. The corresponding content identifiers may be displayed in one or more formats, such as a bubble markers and/or dynamic labels.

Notwithstanding, the disclosure may not be so limited, and other formats may also be implemented to display the content identifiers, without deviation from the scope of the disclosure.

In accordance with an embodiment, the result interface may be further configured to enable the user to perform one or more image/video editing operations on the one or more video images, while the user views the one or more video images through the result interface. Examples of such image/video editing operations may include, but are not limited to, copy-pasting, cut-pasting, deleting, cropping, zooming, panning, rescaling, and/or performing contrast, illumination, or color enhancement on a video image portion. In accordance with an embodiment, the UI manager 310 of the user terminal 108 may transmit information associated with the one or more image/video editing operations performed by the user to the UI manager 214 of the content management server 104, via the transceiver 204. The UI manager 214 of the content management server 104 may accordingly update the video images stored in the video database 106.

In accordance with an embodiment, the result interface may be further configured to enable the user to perform tagging of the one or more video images, while the user views the one or more video images through the result interface. For example, the result interface may enable the user to tag a non-tissue region in a video image being displayed to the user with a correct content identifier, if the user observes that a wrong content identifier is currently associated with the non-tissue region. Further, the result interface may enable the user to identify a region in the video image as a non-tissue region that could not be identified by the content management server 104. The user may tag such non-tissue regions with an appropriate content identifier. The user may also identify regions in the video image that may have been wrongly identified as non-tissue regions, though these may correspond to other artifacts or tissue regions in the video image. In addition, the result interface may enable the user to add annotations and notes at one or more portions of the video images. In accordance with an embodiment, the UI manager 310 of the user terminal 108 may transmit information associated with the tagged one or more video images to the UI manager 214 of the content management server 104, via the transceiver 204. The UI manager 214 of the content management server 104 may accordingly update the video images stored in the video database 106. Further, the indexing engine of the content management server 104 may update the indexing of the video images in the video database 106 to reflect changes in the associations between the content identifiers and the non-tissue regions based on the user's tagging.

FIG. 4 illustrates an exemplary scenario of a UI that may be presented on the user terminal 108, in accordance with an embodiment of the disclosure. FIG. 4 has been described in conjunction with elements of FIG. 1. With reference to FIG. 4, there is shown a UI 400, which may be presented to the user of the user terminal 108. The UI 400 may include a search interface 402 and a result interface 406. In accordance with an embodiment, the search interface 402 may be configured to receive a search query that includes one or more search terms from the user of the user terminal 108. The search interface 402 may include a search bar and a submit button to receive the search query. In accordance with an embodiment, the result interface 406 may be configured to display one or more video image portions that are retrieved from the one or more video images, based on the one or more search terms in the search query.

For instance, the result interface 406 displays a video image portion that includes a snapshot of a perspective cross-sectional view of an anatomical region 408 of a patient. The snapshot may be captured while a surgical or diagnostic procedure is performed on the anatomical region 408. As illustrated in the snapshot, the surgical or diagnostic procedure may be performed by use of one or more surgical instruments, such as surgical forceps 410 and an endoscopic surgical instrument 412. As shown in FIG. 4, a surface of the anatomical region 408 may be held by use of the surgical forceps 410, when the surgical or diagnostic procedure is performed by use of the endoscopic surgical instrument 412. Though only two surgical instruments are shown in FIG. 4, one or more other surgical instruments may also be used to perform the surgical or diagnostic procedure without deviation from the scope of the disclosure. In accordance with an embodiment, the snapshot also illustrates a first non-tissue region, such as blood regions 414a and 414b, within the one or more video image portions. In accordance with an embodiment, the first non-tissue region may be associated with a first content identifier that may correspond to at least one content identifier from the one or more content identifiers, while the first content identifier may be associated with the one or more search terms in the search query.

In operation, the user (such as a physician, a medical student, and/or a medical professional) may enter a search query by inputting one or more search terms through the search interface 402. For instance, the user may enter the search terms, “Frames with blood stains” in the search bar of the search interface 402 and click on or press the submit button (such as the “GO” button) of the search interface 402. The user terminal 108 may transmit the search query entered by the user to the content management server 104 for retrieval of relevant video image portions from the one or more video images. Thereafter, the user terminal 108 may receive the relevant video image portions from the content management server 104, based on the transmitted search query. In accordance with an embodiment, the result interface 406 may be configured to display the one or more video image portions that may be received by the user terminal 108. The one or more search terms in the search query may be associated with a first content identifier. For example, the search term, “blood stains” may be associated with the pre-stored content identifier, “blood region”. The one or more video image portions may be retrieved based on the first content identifier. Further, the one or more video image portions may include a first non-tissue region, such as the blood region associated with the first content identifier. Thus, in the above scenario, the retrieved one or more video image portions may include blood regions, such as the blood regions 414a and 414b. In accordance with an embodiment, the first non-tissue region, such as the blood regions 414a and 414b, may be masked or highlighted within the result interface 406. In accordance with an embodiment, the first non-tissue region may be displayed in a magnified and high-resolution sub-interface within the result interface 406. In accordance with an embodiment, the result interface 406 may display the first non-tissue region, such as the blood regions 414a and 414b, via a picture-in-picture interface or a picture-or-picture interface.

In accordance with an embodiment, in addition to being associated with the first content identifier, the one or more search terms may be further associated with an occurrence of an event in the one or more video images. For example, the search query, “blood stains” may be associated with an event of an initial appearance of a blood region in the one or more video images. Thus, the user may search for a desired video image that corresponds to the initial appearance of a blood region during the course of the surgical or diagnostic procedure. Though not shown in FIG. 4, in such a scenario, the result interface 406 may display a timestamp of such a desired video image to the user. The desired video image may include a first video image portion from the one or more video image portions. The first video image portion from the one or more video image portions correspond to the occurrence of the event, which in this case is the initial occurrence of the blood region. In accordance with an embodiment, the timestamp may be indicative of a relative position of the desired video image with respect to the one or more video images. The result interface 406 may prompt the user with an option to navigate to the desired video image. If the user provides an input indicative of a navigation request to the desired video image, the result interface 406 may present the desired video image to the user. A person having ordinary skill in the art may understand that the UI 400 has been provided for exemplary purposes and should not be construed to limit the scope of the disclosure.

Various embodiments of the disclosure may encompass numerous advantages. The content management server 104 may provide surgical navigation assistance to the user, such as a surgeon, a physician, a medical practitioner, or a medical student, during the surgical or diagnostic procedure. In an instance, the surgical navigation assistance may include bleeding localization to identify the location and source of bleeding during the surgical or diagnostic procedure. In another instance, the surgical navigation assistance may include smoke evacuation and lens cleaning trigger when visibility decreases in case of smoke and/or mist appearance in the surgical region. In another instance, the surgical navigation assistance may include surgical tool warnings when a critical proximity distance of surgical tools from tissue regions is detected. In yet another instance, the surgical navigation assistance may include gauze and/or surgical tool tracking to auto-check for clearance of the gauzes and/or surgical tools from the anatomical regions when the surgical or diagnostic procedure is nearing completion.

The content management server 104 may further enable the user to search for the occurrence of particular events in the one or more video images. In an exemplary scenario, the user may be interested in searching for a start or an end of a specific event in the surgical or diagnostic procedure. Examples of the specific event may include, but are not limited to, a start of bleeding, an appearance of smoke/mist, and/or proximity of surgical instruments to a non-tissue region or a tissue region.

The content management server 104 may further enable the user to directly navigate to relevant sections in the one or more video images that correspond to the searched event. The ability to freely search through a large chunk of video images, based on the content identifiers and predefined events, may be useful for users, such as physicians, medical students, and various other medical professionals. Such an ability to freely search through a large chunk of video images may be beneficial for the users to impart surgical training sessions, preparation of medical case sheets, analysis of procedural errors, and performing surgical reviews on surgical or diagnostic procedures. The content management server 104 may further provide assistance in robotic surgery by use of machine learning engine 218.

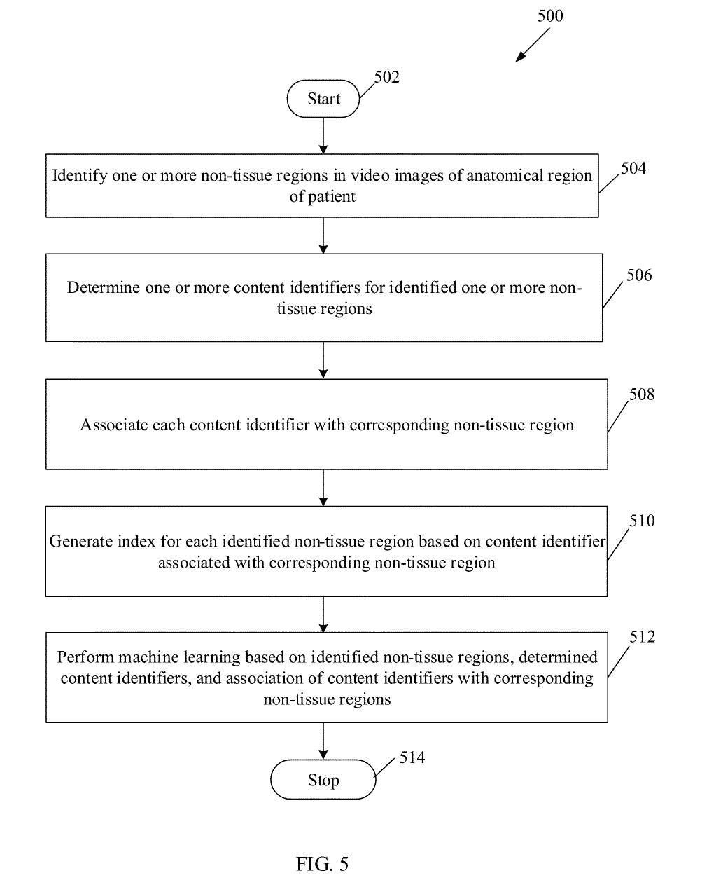

FIG. 5 is a flow chart that illustrates an exemplary method for content management of video images of anatomical regions, in accordance with an embodiment of the disclosure. With reference to FIG. 5, there is shown a flow chart 500. The flow chart 500 is described in conjunction with FIGS. 1 and 2. The method starts at step 502 and proceeds to step 504.

At step 504, one or more non-tissue regions may be identified in one or more video images of an anatomical region of a patient. In accordance with an embodiment, the one or more video images may be captured by the image-capturing device (not shown in FIG. 1), when a surgical or diagnostic procedure is performed on the anatomical region of the patient. In accordance with an embodiment, the one or more video images may be stored in the video database 106. In accordance with an embodiment, the surgical scene analyzer 210 of the content management server 104 may be configured to identify the one or more non-tissue regions based on an analysis of the one or more video images.

At step 506, one or more content identifiers may be determined for the identified one or more non-tissue regions. In accordance with an embodiment, the surgical scene analyzer 210 may be configured to determine the one or more content identifiers. Alternatively, the one or more content identifiers may be predetermined and pre-stored in the memory 206 of the content management server 104, and/or the video database 106. In such a case, the one or more content identifiers need not be determined by the surgical scene analyzer 210. Instead, the one or more content identifiers may be retrieved from the memory 206 or the video database 106.

At step 508, each of the one or more content identifiers may be associated with a corresponding non-tissue region from the one or more non-tissue regions. In accordance with an embodiment, the surgical scene analyzer 210 may be configured to associate each of the one or more content identifiers with the corresponding non-tissue region in the one or more video images.

At step 510, an index may be generated for each of the identified one or more non-tissue regions, based on the content identifier associated with the corresponding non-tissue region. In accordance with an embodiment, the indexing engine (not shown in FIG. 2) of the content management server 104 may be configured to generate the index. In accordance with an embodiment, the indexing engine may index each video image stored in the video database 106, based on the index generated for each of the one or more non-tissue regions.

At step 512, machine learning may be performed based on the identified one or more non-tissue regions, the determined one or more content identifiers, and the association of each content identifier with the corresponding non-tissue regions. In accordance with an embodiment, the machine learning engine 218 may be configured to perform the machine learning. Based on the machine learning, the machine learning engine 218 may formulate one or more rules or update one or more previously formulated rules. In accordance with an embodiment, the surgical scene analyzer 210 may use the one or more rules to analyze one or more new video images and associate each content identifier with a corresponding non-tissue region in the one or more new video images. Control passes to end step 514.

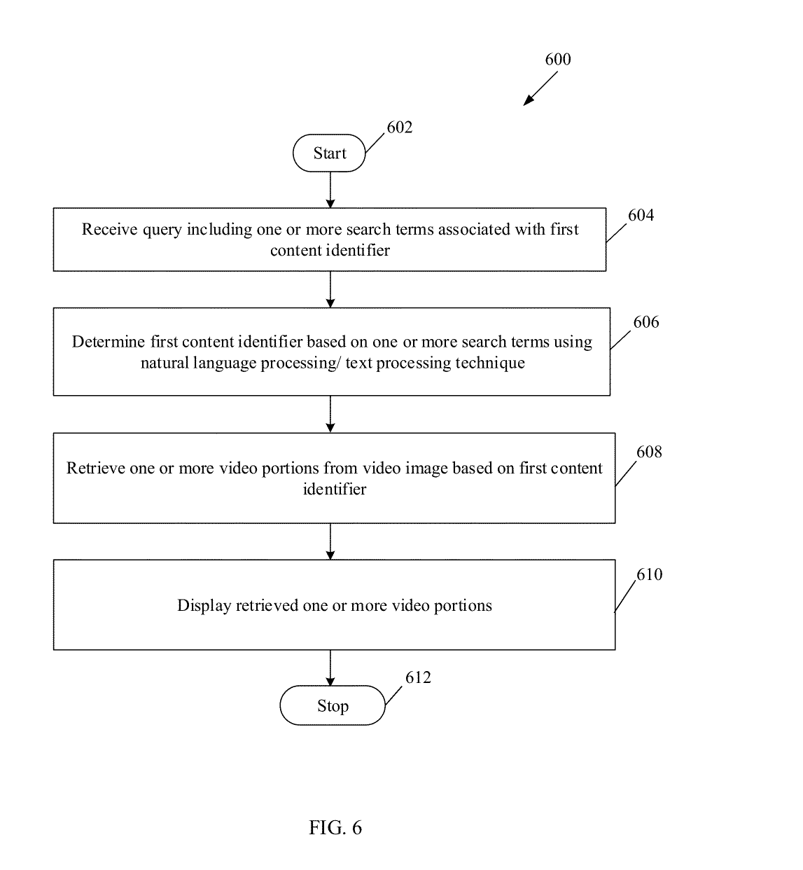

FIG. 6 is an exemplary flow chart that illustrates a second exemplary method for content retrieval, in accordance with an embodiment of the disclosure. With reference to FIG. 6, there is shown a flow chart 600. The flow chart 600 is described in conjunction with FIGS. 1 and 2. The method starts at step 602 and proceeds to step 604.

At step 604, a query may be received from the user terminal 108. In accordance with an embodiment, the UI manager 214 of the content management server 104 may be configured to receive the query, via the transceiver 204. In accordance with an embodiment, the query may include one or more search terms associated with a first content identifier.

At step 606, the first content identifier may be determined based on the one or more search terms by use of one or more natural language processing and/or text processing techniques. In accordance with an embodiment, the natural language parser 216 of the content management server 104 may be configured to determine the first content identifier.

At step 608, one or more video image portions may be retrieved from the one or more video images, based on the first content identifier. In accordance with an embodiment, the UI manager 214 of the content management server 104 may be configured to retrieve the one or more video image portions from the video database 106. In accordance with an embodiment, the retrieved one or more video image portions may include a first non-tissue region, which is associated with the first content identifier.

At step 610, the retrieved one or more video image portions are displayed. In accordance with an embodiment, the UI manager 214 may be configured to display the retrieved one or more video image portions to the user through the UI of the user terminal 108. In accordance with an embodiment, the first non-tissue region may be masked or highlighted within the one or more video image portions, when the one or more video image portions are displayed to the user. Control passes to end step 612.

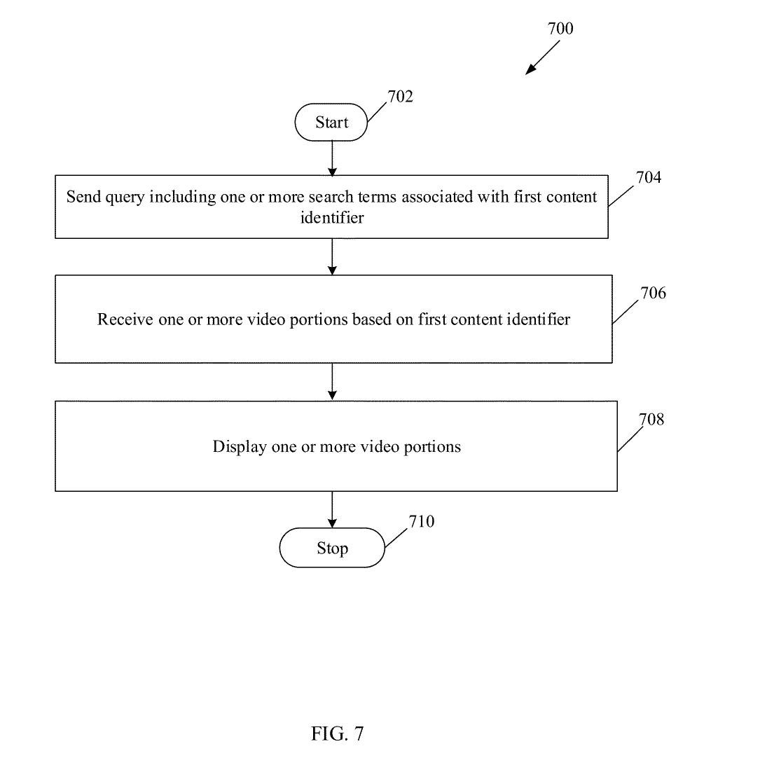

FIG. 7 is an exemplary flow chart that illustrates a third exemplary method for content retrieval, in accordance with an embodiment of the disclosure. With reference to FIG. 7, there is shown a flow chart 700. The flow chart 700 is described in conjunction with FIGS. 1 and 3. The method starts at step 702 and proceeds to step 704.

At step 704, a query that includes one or more search terms may be sent. In accordance with an embodiment, the UI manager 310 of the user terminal 108 may be configured to receive the query from the user through the UI of the user terminal 108. Thereafter, the UI manager 310 may be configured to send the query to the content management server 104, via the transceiver 304. In accordance with an embodiment, the one or more search terms may be associated with a first content identifier.

At step 706, one or more video image portions may be received. In accordance with an embodiment, the UI manager 310 may be configured to receive the one or more video image portions from the content management server 104, via the transceiver 304. In accordance with an embodiment, the content management server 104 may retrieve the one or more video image portions from the one or more video images indexed and stored in the video database 106, based on the first content identifier. In accordance with an embodiment, the one or more video image portions may include a first non-tissue region, which may be associated with the first content identifier.

At step 708, the one or more video image portions may be displayed. In accordance with an embodiment, the UI manager 310 may be configured to display the one or more video image portions on the display device 314 of the user terminal 108, via the UI of the user terminal 108. In accordance with an embodiment, the first non-tissue region may be masked or highlighted within the displayed one or more video image portions. In accordance with an embodiment, the first non-tissue region may be displayed within a picture-in-picture interface or a picture-on-picture interface. Control passes to end step 710.

In accordance with an embodiment of the disclosure, a system for content management is disclosed. The system may comprise the content management server 104. The content management server 104 may be configured to identify one or more non-tissue regions in a video image of an anatomical region. The video image may be generated by the image-capturing device, which may be communicatively coupled to the content management server 104, via the communication network 110. The content management server 104 may be further configured to determine one or more content identifiers for the identified one or more non-tissue regions. In addition, the content management server 104 may be configured to associate each of the determined one or more content identifiers with a corresponding non-tissue region of the identified one or more non-tissue regions.

Various embodiments of the disclosure may provide a non-transitory computer or machine readable medium and/or storage medium that has stored thereon, a machine code and/or a computer program with at least one code section executable by a machine and/or a computer for content management of video images of anatomical regions. The at least one code section in the content management server 104 may cause the machine and/or computer to perform the steps that comprise identification of one or more non-tissue regions in a video image of an anatomical region. The video image may be generated by the image-capturing device, which may be communicatively coupled to the content management server 104, via the communication network 110. In accordance with an embodiment, one or more content identifiers may be determined for the identified one or more non-tissue regions. Further, each of the determined one or more content identifiers may be associated with a corresponding non-tissue region from the identified one or more non-tissue regions.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features enabling the implementation of the methods described herein, and which when loaded in a computer system is able to carry out these methods. Computer program, in the present context, means any expression, in any language, code or notation, of a set of instructions intended to cause a system with an information processing capability to perform a particular function either directly, or after either or both of the following: a) conversion to another language, code or notation; b) reproduction in a different material form.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. A system for content management of video images of anatomical regions, said system comprising:
one or more circuits in a content processing device communicatively coupled to an image-capturing device, said one or more circuits being configured to:
identify one or more non-tissue regions in a video image of an anatomical region, wherein said video image is generated by said image-capturing device;
determine one or more content identifiers for said identified one or more non-tissue regions; and
associate each of said determined one or more content identifiers with a corresponding non-tissue region of said identified one or more non-tissue regions.

2. The system of claim 1, wherein said identified one or more non-tissue regions comprise one or more of a smoke/mist region, a surgical instrument region, a surgical gauze region, or a blood region.

3. The system of claim 1, wherein said one or more circuits are further configured to generate an index for each of said identified one or more non-tissue regions in said video image based on each of said determined one or more content identifiers associated with said corresponding non-tissue region.

4. The system of claim 1, wherein said one or more circuits are further configured to receive a query comprising one or more search terms, wherein said one or more search terms are associated with at least a first content identifier.

5. The system of claim 4, wherein said one or more circuits are further configured to determine said first content identifier associated with said one or more search terms using a natural language processing or a text processing technique.

6. The system of claim 4, wherein said one or more circuits are further configured to retrieve one or more video image portions from said video image based on said first content identifier, wherein said retrieved one or more video image portions include at least a first non-tissue region, from said identified one or more non-tissue regions, corresponding to said first content identifier.

7. The system of claim 6, wherein said one or more circuits are further configured to display said retrieved one or more video image portions.

8. The system of claim 7, wherein said one or more circuits are further configured to mask/highlight said first non-tissue region within said displayed one or more video image portions.

9. The system of claim 7, wherein said retrieved one or more video image portions are displayed via a picture-on-picture interface or a picture-in-picture interface.

10. The system of claim 6, wherein said one or more circuits are further configured to display a timestamp corresponding to said video image comprising a first video image portion from said retrieved one or more video image portions.

11. The system of claim 10, wherein said first video image portion corresponds to an occurrence of at least an event in said video image.

12. The system of claim 11, wherein said event includes one of an initial appearance of said first non-tissue region within said video image, a final appearance of said first non-tissue region within said video image, a proximity of said first non-tissue region with a tissue region, and/or another proximity of said first non-tissue region with another non-tissue region of said one or more non-tissue regions.

13. The system of claim 11, wherein said one or more search terms are further associated with said occurrence of at least said event.

14. The system of claim 1, wherein said one or more circuits are further configured to perform machine learning based on said identified one or more non-tissue regions, said determined one or more content identifiers, and said association of each of said determined one or more content identifiers with said corresponding non-tissue region.

15. A method for content management of video images of anatomical regions, said method comprising:
in a content processing device communicatively coupled to an image-capturing device:
identifying one or more non-tissue regions in a video image of an anatomical region, wherein said video image is generated by said image-capturing device;
determining one or more content identifiers for said identified one or more non-tissue regions; and
associating each of said determined said one or more content identifiers with a corresponding non-tissue region of said identified one or more non-tissue regions.

16. The method of claim 15, wherein said identified one or more non-tissue regions comprise one or more of a smoke/mist region, a surgical instrument region, a surgical gauze region, or a blood region.

17. The method of claim 15, further comprising receiving a query comprising one or more search terms, wherein said one or more search terms are associated with at least a first content identifier.

18. The method of claim 17, further comprising determining said first content identifier associated with said one or more search terms using a natural language processing or a text processing technique.

19. The method of claim 17, further comprising retrieving one or more video image portions from said video image based on said first content identifier, wherein said retrieved one or more video image portions include at least a first non-tissue region, from said identified one or more non-tissue regions, corresponding to said first content identifier.

20. The method of claim 19, further comprising displaying said retrieved one or more video image portions.

21. A method for content management of video images of anatomical regions, said method comprising:
in an electronic device communicatively coupled to a content processing device:
receiving, via a user interface (UI) of said electronic device, a query comprising one or more search terms, wherein said one or more search terms are associated with at least a first content identifier that corresponds to at least one content identifier from one or more content identifiers, wherein each of said one or more content identifiers are associated with a corresponding non-tissue region of one or more non-tissue regions identified in a video image of an anatomical region, wherein said video image is generated by an image-capturing device communicatively coupled to said content processing device; and
displaying, via said UI, one or more video image portions from said video image based on said first content identifier, wherein said displayed one or more video image portions include at least a first non-tissue region, from said one or more non-tissue regions, corresponding to said first content identifier.

22. The method of claim 21, wherein said one or more non-tissue regions comprise one or more of a smoke/mist region, a surgical instrument region, a surgical gauze region, or a blood region.

23. A non-transitory computer readable storage medium having stored thereon, a program having at least one code section executable by a computer, thereby causing the computer to perform steps comprising:
in a content processing device communicatively coupled to an image-capturing device:
identifying one or more non-tissue regions in a video image of an anatomical region, wherein said video image is generated by said image-capturing device;
determining one or more content identifiers for said identified one or more non-tissue regions; and
associating each of said determined said one or more content identifiers with a corresponding non-tissue region of said identified one or more non-tissue regions.
